(19) United States
(12) Patent Application Publication
(10) Pub. No.: US 2011/0010256 A1
(43) Pub. Date: Jan. 13, 2011

(54) COMMODITY SALES SYSTEM, HANDY TERMINAL, AND METHOD OF CONTROLLING THE HANDY TERMINAL

(75) Inventor: Seiji Yoshimoto, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/832,266

(22) Filed: Jul. 8, 2010

(30) Foreign Application Priority Data
Jul. 9, 2009 (JP) 2009-162951

(51) Int. Cl. G06Q 30/00; G06K 7/10

(52) U.S. Cl. 705/23; 235/375; 235/383

(57) ABSTRACT

According to one embodiment, a handy terminal includes an information detecting unit, a storing unit, and an output unit. The information detecting unit detects commodity information of a commodity purchased by a customer and benefit information indicating content of a benefit provided to the customer. The storing unit stores the commodity information and the benefit information detected by the information detecting unit. The output unit outputs the commodity information and the benefit information stored in the storing unit to a commodity sales data processing apparatus configured to subject the commodity indicated by the commodity information to sales processing.

### CROSS-REFERENCE TO RELATED APPLICATIONS

This application is based upon and claims the benefit of priority from Japanese Patent Application No. 2009-162951, filed Jul. 9, 2009; the entire contents of which are incorporated herein by reference.

### FIELD

Embodiments described herein relates generally to a commodity sales system in which a customer himself or herself inputs a commodity code and carries on a checkout job in a commodity sales store, a handy terminal used in the system, and a method of controlling the handy terminal.

### BACKGROUND

In the past, in checkout jobs in commodity sales stores such as a supermarket and a convenience store, a commodity sales data processing apparatus such as a POS (Point Of Sales) terminal including a barcode scanner for reading barcodes attached to commodities is used.

The apparatus of this type is operated by a store clerk. The store clerk reads a barcode attached to a commodity with the barcode scanner and inputs a commodity code, acquires commodity information including a commodity name and a unit price from a database of a store server or the like on the basis of the commodity code, and registers, in a predetermined storage area formed in a memory, sales data in which the number of items of a purchased commodity and the like are added to the commodity information. The store clerk calculates a price and issues a receipt on the basis of sales data registered in one transaction and completes the checkout job.

In recent years, in order to reduce personnel assigned to the checkout job and realize efficiency of the job, a commodity sales system employing a PSS (Personal Self Shopping) system in which a customer himself or herself performs, for example, reading of a barcode is spreading. Such a system is disclosed in, for example, JP-A-10-241044.

In the system of this type, a handy terminal having a barcode scanning function is handed to a customer who visits a store. The customer scans, when the customer himself or herself puts a commodity in a shopping basket, a barcode attached to the commodity using the handy terminal and inputs a commodity code. At this point, the handy terminal accesses a store server through radio communication, acquires commodity information associated with the commodity code from the database, generates sales data on the basis of the commodity information, and registers the sales data in a storage area in a memory included in the handy terminal.

When registration of a series of commodities is finished in this way, the customer transmits sales data stored in the handy terminal to a commodity sales data processing apparatus. The customer completes a checkout job by himself or herself or under the initiative of the store clerk using the commodity sales data processing apparatus.

In a retail store or the like, in some case, a coupon such as a price-cut ticket or a discount ticket is distributed as a part of sales promotion activities. On a coupon in these days, a barcode representing a type of a benefit is printed. It is possible to easily input a price-cut amount or a discount rate to the commodity sales data processing apparatus by scanning the barcode.

In the current commodity sales system of the PSS system, means for processing a benefit by a coupon with a handy terminal is not taken. Therefore, when the sales promotion activities are introduced into the commodity sales system of the PSS system, the store clerk or the customer himself or herself needs to perform work for, for example, scanning the barcode attached to the coupon using a scanner connected to the commodity sales data processing apparatus set on a register counter.

However, when the customer visits the store intending to use the coupon, in some case, the customer forgets the presence of the coupon during shopping and fails to use the coupon. Since the benefit by the coupon is reflected on a price only during checkout at the register counter, it is difficult for the customer to understand, during the shopping, an accurate price with the benefit by the coupon taken into account.

Under such circumstances, in the commodity sales system employing the PSS system, it is necessary to improve service for the customer to enable the user to register the benefit by the coupon even during the shopping and learn an accurate price on which the benefit is reflected.

### BRIEF DESCRIPTION OF THE DRAWINGS

FIG. 1 is a diagram of a commodity sales system in an embodiment;

FIG. 2 is a diagram of an example of a data structure of a benefit information table in the embodiment;

FIG. 3 is a schematic diagram of the external configuration of a handy terminal in the embodiment;

FIG. 4 is a block diagram of a control circuit for the handy terminal in the embodiment;

FIG. 5 is a schematic diagram of a data structure of a sales data registration area in the embodiment;

FIG. 6 is a schematic diagram of a data structure of a benefit data registration area in the embodiment;

FIG. 7 is a block diagram of a control circuit for a server apparatus in the embodiment;

FIG. 8 is a flowchart for explaining processing executed by a CPU in sales data registration processing in the embodiment; and

FIG. 9 is a schematic diagram of an example of a registration screen in the embodiment.

### DETAILED DESCRIPTION

In general, according to one embodiment, a handy terminal includes an information detecting unit, a storing unit, and an output unit. The information detecting unit detects commodity information of a commodity purchased by a customer and benefit information indicating content of a benefit provided to the customer. The storing unit stores the commodity information and the benefit information detected by the information detecting unit. The output unit outputs the commodity information and the benefit information stored in the storing unit to a commodity sales data processing apparatus configured to subject the commodity indicated by the commodity information to sales processing.

An embodiment is explained below with reference to the accompanying drawings. In the following explanation, components having the same functions and configurations are denoted by the same reference numerals and signs and redundant explanation of the components is provided only when necessary.

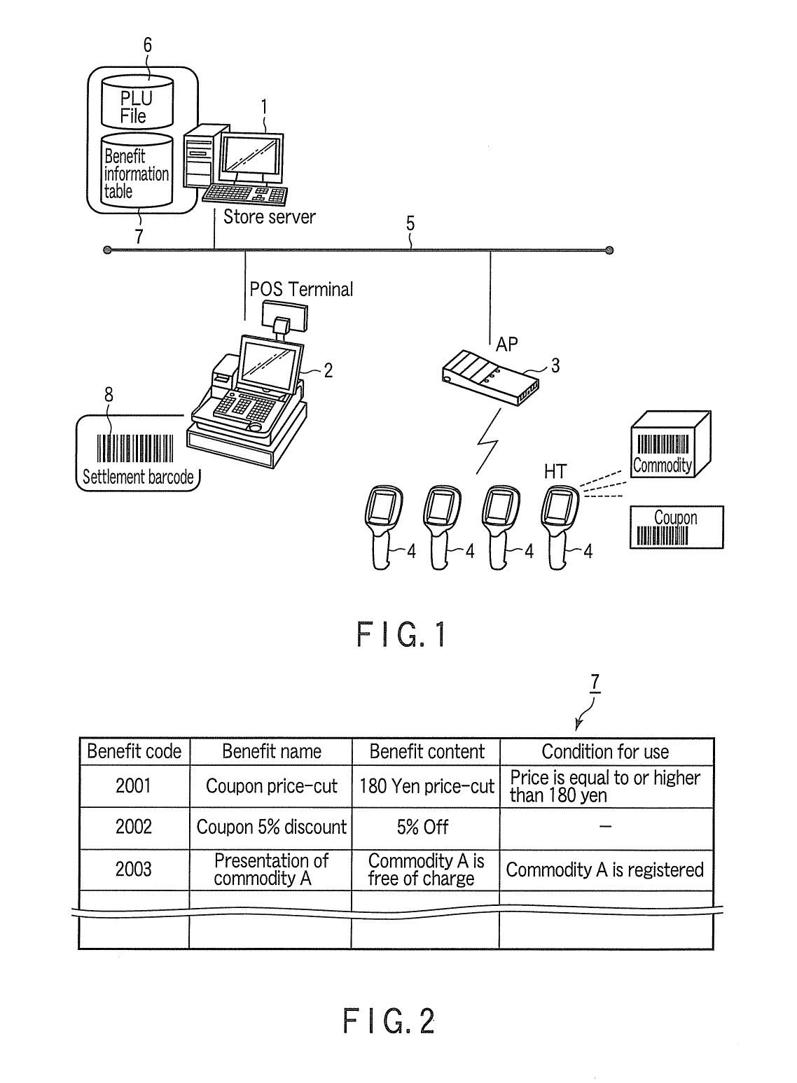

FIG. 1 is a diagram of a commodity sales system in this embodiment.

The system is a commodity sales system of a self scanning type including a store server 1, a POS terminal 2, an access point 3, and plural handy terminals 4. In the system, a customer himself or herself performs a registration job for commodity information. The store server 1, the POS terminal 2, and the access point 3 are connected to be capable of communicating one another by a LAN (Local Area Network) 5.

The store server 1 functions as a server apparatus in this embodiment. The store server 1 stores and manages, for example, sales data and the like in a store in which the commodity sales system operates, a PLU (Price Look Up) file 6 functioning as a commodity-information storing unit in this embodiment, and a benefit information table 7 functioning as a benefit-information storing unit in this embodiment.

In the PLU file 6, commodity information including a commodity name and a unit price is described with respect to a commodity code (an identifier for a commodity) uniquely allocated to each commodity. The benefit information table 7 is a database in which information concerning coupons is registered. The benefit information table 7 has, for example, a data structure shown in FIG. 2. Specifically, a benefit name, benefit content, and a condition for use of a coupon (a condition for application of a benefit indicated by benefit information) are described with respect to a benefit code (an identifier of a benefit) uniquely allocated to each benefit. In the example shown in FIG. 2, information indicating a benefit name “coupon price-cut”, benefit content “180 yen price-cut”, and a condition for use “a price is equal to or higher than 180 yen” is described with respect to a benefit code “2001”. Information indicating a benefit name “coupon 5% discount”, benefit content “5% off”, and a condition for use “-” (no condition) is described with respect to a benefit code “2002”. Information indicating a benefit name “presentation of a commodity A”, benefit content “the commode A is free of charge”, and a condition for use “the commodity A is registered” is described with respect to a benefit code “2003”.

The POS terminal 2 functions as the commodity sales data processing apparatus in this embodiment. The POS terminal 2 is placed on a register counter to which a settlement barcode 8 used in processing explained later is stuck. A main body of the POS terminal 2 includes a keyboard on which various operation keys are disposed, a display unit configured to display various kinds of information to a store clerk or a customer, a receipt printer configured to issue a receipt, and a coin input unit, a bill input unit, a coin discharge unit, and a bill discharge unit used for exchange of cash and change. A store clerk is not posted at a register counter where the POS terminal 2 is set. Specifically, the POS terminal 2 is a POS terminal of a self checkout type that a customer himself or herself operates to perform checkout processing such as payment of a price.

When the access point 3 receives a radio wave transmitted from the handy terminal 4, the access point 3 generates digital data on the basis of a high-frequency signal obtained from the radio wave and transmits the digital data to the LAN 5. When the access point 3 receives, via the LAN 5, transmission data to the handy terminal 4, the access point 3 generates a high-frequency signal on the basis of the transmission data and transmits the high-frequency signal to the handy terminal 4 as a radio wave.

The handy terminal 4 is handed to a customer who visits the store and collected when the customer leaves the store. The customer reads a barcode attached to a commodity and a barcode attached to a coupon by himself or herself using the handy terminal 4 and inputs a commodity code and a benefit code represented by the barcodes to the handy terminal 4.

FIG. 3 is a schematic diagram of an example of the external configuration of the handy terminal 4. The handy terminal 4 includes a grip 10, an operation unit 11 including operation buttons 110 to 115, and a display unit 12, for example, an LCD (Liquid Crystal Display). A reading window for a scanner not shown in the figure is provided on the rear surface of the handy terminal 4.

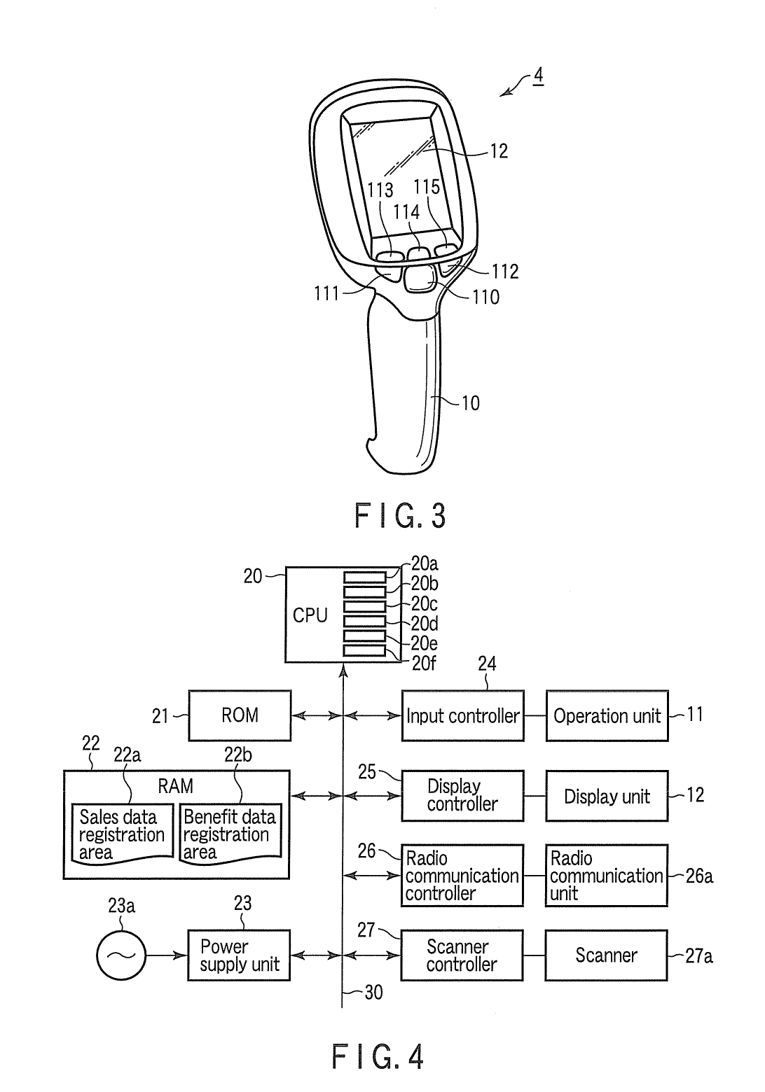

A control circuit for the handy terminal 4 is shown in FIG. 4. The control circuit is configured by connecting, to a CPU 20 functioning as a main control unit for the handy terminal 4, a ROM (Read Only Memory) 21, a RAM (Random Access Memory) 22, a power supply unit 23, an input controller 24, a display controller 25, a radio communication controller 26, and a scanner controller 27 via a bus line 30 such as an address bus or a data bus.

A battery 23a is connected to the power supply unit 23, the operation unit 11 is connected to the input controller 24, the display unit 12 is connected to the display controller 25, a radio communication unit 26a is connected to the radio communication controller 26, and a scanner 27a is connected to the scanner controller 27.

The ROM 21 is a nonvolatile memory and has stored therein, for example, a basic computer program necessary for the operation of the handy terminal 4 and unique terminal IDs allocated to terminals connected to the LAN 5.

Various storage areas for work are formed in the RAM 22 according to processing situations. For example, when registration processing for sales data is executed, a sales data registration area 22a and a benefit data registration area 22b functioning as storing units in this embodiment are formed in the RAM 22.

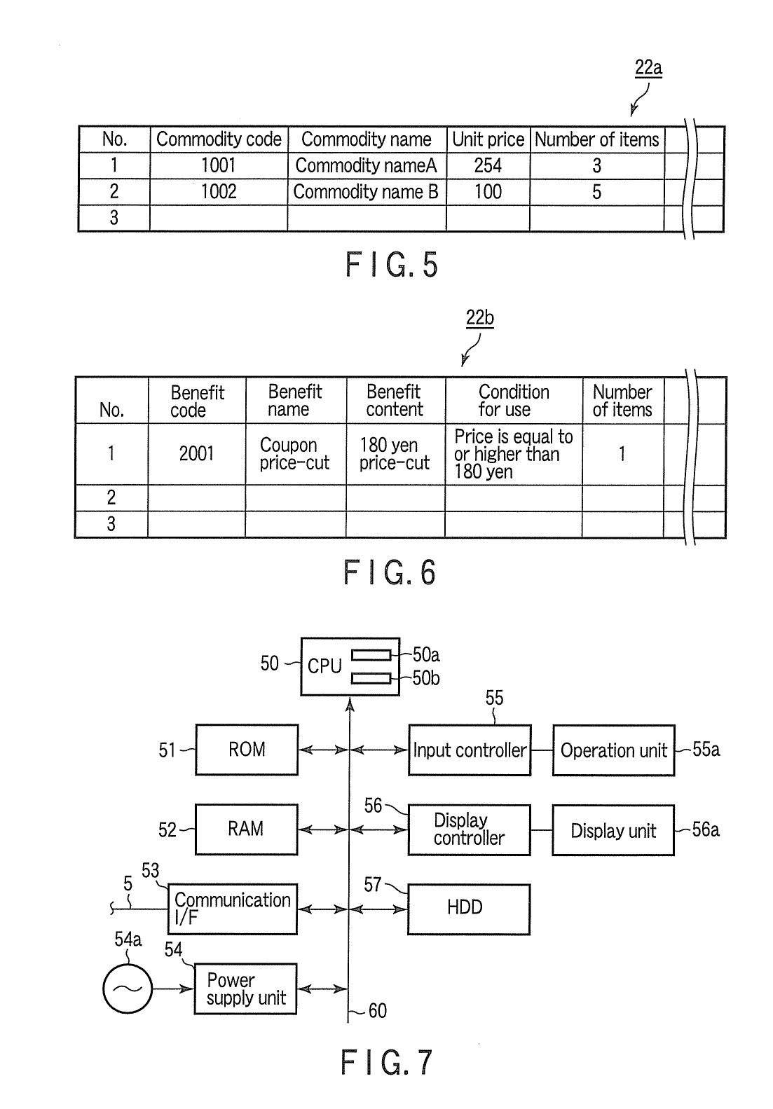

The sales data registration area 22a is a storage area for work for registering commodity information and the like and has, for example, a data structure shown in FIG. 5. Specifically, a registration area for sales data in which the number of sold items of a sold commodity is added to commodity information including a commodity code, a commodity name, a unit price, and the like of the commodity is formed. In an example shown in the figure, sales data including a commodity code “1001”, a commodity name “commodity A”, a unit price “245” yen, and the number of items “3” is registered in an area No. 1. Sales data including a commodity code “1002”, a commodity name “commodity B”, a unit price “100” yen, and the number of items “5” is registered in an area No. 2.

The benefit data registration area 22b is a storage area for work for registering benefit information and has, for example, a data structure shown in FIG. 6. Specifically, a registration area for benefit data in which the number of registered items of benefit data is added to benefit information including a benefit code, a benefit name, benefit content, and a condition for use is formed. In an example shown in the figure, benefit data including a benefit code “2001”, a benefit name “coupon price-cut”, benefit content “180 yen price-cut”, a condition for use “a price is equal to or higher than 180 yen”, and the number of registered items “1” is registered in the area No. 1.

The power supply unit 23 captures operation power from the battery 23a and supplies the operation power to the units of the handy terminal 4. When an external power supply such as a commercial AC power supply is connected to a not-shown connector, the power supply unit 23 captures power from the external power supply, supplies the power to the battery 23a, and charges the battery 23a. The battery 23a is detachably attached to the handy terminal 4 and can be easily removed from a housing and replaced.

The input controller 24 monitors depression of the operation buttons 110 to 115 included in the operation unit 11 and notifies a CPU 20 of a signal corresponding to a depressed operation button.

The display controller 25 converts image data sent from the CPU 20 into a video signal, outputs the video signal to the display unit 12, and causes the display unit 12 to selectively display various kinds of information.

The radio communication controller 26 controls radio communication with the access point 3 by the radio communication unit 26a. The radio communication unit 26a includes a transmitting unit configured to modulate data sent from the radio communication controller 26 into a high-frequency signal, an antenna configured to emit a radio wave based on the high-frequency signal modulated by the transmitting unit and generate a high-frequency signal based on the radio wave emitted by the access point 3, and a receiving unit configured to demodulate the high-frequency signal generated by the antenna into digital data.

The scanner controller 27 controls the scanner 27a to control timing for reading a barcode (a symbol code) and notifies the CPU 20 of barcode data detected by the scanner 27a. The scanner 27a includes a photosensor configured to optically read a barcode and output an analog signal, an A/D converter configured to convert the analog signal output from the photosensor into a digital signal, and a decoder configured to decode the digital signal output from the A/D converter into barcode data. The scanner 27a functions as a reading unit in this embodiment.

In the handy terminal 4 having such a configuration, the CPU 20 executes the operation program stored in the ROM 21 to thereby realize units explained in (1) to (6) below.

(1) An information detecting unit 20a (or a transmission and reception control unit) configured to detect commodity information of a commodity purchased by a customer and benefit information indicating content of a benefit provided to the customer. In particular, the information detecting unit 20a transmits, with the radio communication unit 26a, barcode data input when a barcode attached to a commodity is scanned by the scanner 27a and barcode data input when a barcode attached to a coupon is scanned by the scanner 27a to the store server 1 and receives, with the radio communication unit 26a, commodity information and benefit information returned by the store server 1 according to the received barcode data to detect the commodity information and the benefit information.

(2) A condition detecting unit 20b configured to detect a condition for application of content of a benefit indicated by the benefit information detected by the information detecting unit 20a.

(3) A storage control unit 20c configured to store, when benefit information same as the benefit information detected by the information detecting unit 20a is not stored in the benefit data registration area 22b and the condition for application detected by the condition detecting unit 20b is satisfied, the detected benefit information in the benefit data registration area 22b and discard, when benefit information same as the benefit information detected by the information detecting unit 20a is stored in the benefit data registration area 22b and the condition for application detected by the condition detecting unit 20b is not satisfied, the detected benefit information.

(4) A calculating unit 20d configured to calculate a price of a relevant transaction on the basis of commodity information and benefit information stored in the sales data registration area 22a and the benefit data registration area 22b.

(5) A display control unit 20e configured to display, on the display unit 12, the price calculated by the calculating unit 20d and the commodity information and the benefit information stored in the sales data registration area 22a and the benefit data registration area 22b.

(6) An output unit 20f configured to output the commodity information and the benefit information stored in the sales data registration area 22a and the benefit data registration area 22b to the POS terminal 2. In particular, the output unit 20f outputs the commodity information and the benefit information stored in the sales data registration area 22a and the benefit data registration area 22b to the POS terminal 2 when the settlement barcode 8 is scanned by the scanner 27a and barcode data of the settlement barcode 8 is input.

A control circuit for the store server 1 is shown in FIG. 7. The control circuit is configured by connecting, to a CPU 50 functioning as a main control unit for the store server 1, a ROM 51, a RAM 52, a communication interface 53, a power supply unit 54, an input controller 55, a display controller 56, and an HDD (Hard Disk Drive) 57 via a bus line 60 such as an address bus or a data bus.

The LAN 5 is connected to the communication interface 53, a power supply 54a such as the commercial AC power supply is connected to the power supply unit 54, an operation unit 55a is connected to the input controller 55, and a display unit 56a is connected to the display controller 56.

The ROM 51 is a nonvolatile memory and has stored therein, for example, a basic computer program necessary for the operation of the store server 1 and terminal IDs uniquely allocated to terminals connected to the LAN 5.

Various storage areas for work are formed in the RAM 52 according to processing situations.

The communication interface 53 controls communication with the POS terminal 2 and the access point 3 performed via the LAN 5.

The power supply unit 54 captures operation power from the power supply 54a and supplies the operation power to the units of the store server 1.

The operation unit 55a includes a keyboard on which alphabet keys and a ten key are disposed and a pointing device such as a mouse. The input controller 55 monitors operation applied to the operation unit 55a and notifies the CPU 20 of a signal corresponding to detected operation.

The display unit 56a is, for example, an LCD. The display controller 56 converts image data sent from the CPU 50 into a video signal, outputs the video signal to the display unit 56a, and causes the display unit 56a to selectively display various kinds of information.

The HDD 57 has stored therein the PLU file 6, the benefit information table 7, and the like.

In the store server 1 having such a configuration, the CPU 50 executes the operation program stored in the ROM 51 to thereby realize units explained in (7) and (8) below.

(7) An information specifying unit 50a configured to specify, when barcode data of a barcode attached to a commodity is received from the handy terminal 4, commodity information associated with the barcode data from the PLU file 6 and specify, when barcode data of a barcode attached to a coupon is received from the handy terminal 4, benefit information associated with the barcode data from the benefit information table 7.

(8) A return control unit 50b configured to return the commodity information and the benefit information specified by the information specifying unit 50a to the handy terminal 4.

The operation of the handy terminal 4 having the configuration explained above is explained below.

When a customer visits a store and starts registration of sales data after the handy terminal 4 is handed to the customer, the customer depresses a registration start button provided in the operation unit 11. With the depression of the registration start button as a trigger, the operation program for sales data registration stored in the ROM 21 is loaded to the RAM 22, the units 20a to 20f are realized, and sales data registration processing is started.

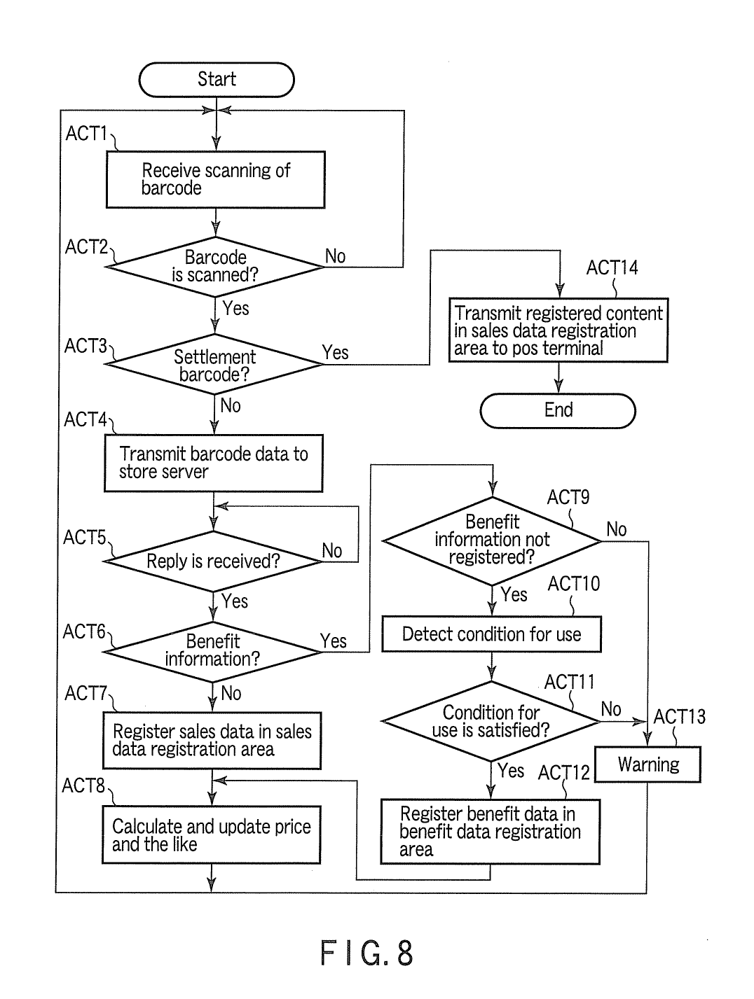

FIG. 8 is a flowchart of processing executed by the CPU 20 in the sales data registration processing.

First, the CPU 20 stays on standby in a state for receiving scanning of a barcode by the scanner 27a (Acts 1 and 2).

If a barcode is scanned by operation by a customer (Yes in Act 2), the CPU 20 determines whether the barcode is the settlement barcode 8 (Act 3). Barcode data of the settlement barcode 8 is stored in the ROM 21 in advance. Whether the scanned barcode is the settlement barcode 8 is determined according to coincidence or non-coincidence of the barcode data stored in the ROM 21 and the barcode data detected by the scanning.

If the barcode data detected by the scanning and the barcode data of the settlement barcode 8 do not coincide with each other, the CPU 20 determines that the scanned barcode is not the settlement barcode 8 (No in Act 3). The CPU 20 causes the radio communication controller 26 to drive the radio communication unit 26a and transmit the barcode data detected by the scanning and a terminal ID of the handy terminal 4 to the store server 1 (Act 4). The CPU 20 waits for a reply from the store server 1 (Act 5).

The access point 3 receives the barcode data and the terminal ID transmitted from the radio communication unit 26a and transmits these data to the store server 1 via the LAN 5.

When the data from the access point 3 is received by the communication interface 53, the CPU 50 of the store server 1 searches through the PLU file 6 to find the barcode data in the received data. As a result of the search, if the CPU 50 finds a commodity code that coincides with the barcode data, the CPU 50 creates return data with the handy terminal 4 indicated by the terminal ID in the received data set as a destination and added with commodity information associated with the found commodity code and transmits the return data to the LAN 5.

On the other hand, as a result of the search, if the CPU 50 cannot find a commodity code that coincides with the barcode data, the CPU 50 searches through the benefit information table 7 to find a benefit code that coincides with the barcode data. If the CPU 50 finds a benefit code that coincides with the barcode data, the CPU 50 creates return data with the handy terminal 4 indicated by the terminal ID in the received data set as a destination and added with benefit information associated with the found benefit code and transmits the return data to the LAN 5 via the communication interface 53.

The access point 3 receives, via the LAN 5, the return data transmitted from the store server 1 and transmits the data to the handy terminal 4 through radio communication.

If the handy terminal 4 receives the return data transmitted from the access point 3 in this way (Yes in Act 5), the CPU 20 of the handy terminal 4 determines whether the return data is data concerning benefit information (Act 6). The CPU 20 may perform this determination paying attention to, for example, a difference between a code system of a barcode attached to a commodity and a code system of a barcode attached to a coupon. Alternatively, the CPU 20 may cause the store server 1 to return the return data with identifiers for distinguishing the commodity information and the benefit information attached thereto and perform the determination on the basis of the identifiers.

If the return data is data concerning commodity information (No in Act 6), the CPU 20 combines the received commodity information with the number of items of a sold commodity to create sales data and registers the sales data in the sales data registration area 22a formed in the RAM 22 (Act 7). If the customer designates the number of items of the sold commodity via the operation unit 11, the CPU 20 creates and registers sales data in which the designated number of items of the sold commodity and the commodity information are combined. If the number of items of the sold commodity is not designated, the CPU 20 creates and registers sales data in which the number of items of the sold commodity is “1”.

After registering the sales data in the sales data registration area 22a, the CPU 20 calculates a price of the currently-registered commodity on the basis of the unit price and the number of items of the sold commodity of the sales data registered in the sales data registration area 22a and the benefit content and the number of registered items of benefit data registered in the benefit data registration area 22b, updates a price displayed on the display unit 12 using the calculated price, and adds content of the sales data added anew to the display content of the display unit 12 (Act 8). Thereafter, the CPU 20 shifts to the state for receiving scanning of a barcode again and waits for the next scanning (Acts 1 and 2).

In such processing, when the customer takes out a coupon and scans a barcode attached to the coupon, benefit information is returned from the store server 1. When this return data is received, the CPU 20 determines that the return data is data concerning the benefit information (Yes in Act 6).

First, the CPU 20 determines whether the benefit information is benefit information not registered in the benefit data registration area 22b (Act 9). The CPU 20 searches through the benefit data registration area 22b to find a benefit code included in the benefit information and performs the determination on the basis of whether a benefit code same as the benefit code can be found. If the same benefit code is not found, the CPU 20 determines that the benefit information is not registered (Yes in Act 9) and detects a condition for use included in the benefit information (Act 10). The CPU 20 determines whether the condition for use is satisfied (Act 11).

For example, in the case of the benefit information of the benefit code “2001” shown in FIG. 2, the condition for use is “a price is equal to or higher than 180 yen”. Therefore, the CPU 20 determines whether a price for a relevant transaction calculated from the sales data currently registered in the sales data registration area 22a is equal to or higher than 180 yen. In the case of the benefit information of the benefit code “2003”, the condition for use is “the commodity A is registered”. Therefore, the CPU 20 determines whether sales data concerning the commodity A is registered in the sales data registration area 22a. When other benefit data is registered in the benefit data registration area 22b or when the number of registered items of one benefit data is plural, the CPU 20 determines whether a condition for use is satisfied in a state in which the items of the benefit data are reflected on a price and the like.

As a result of determining whether the condition for use is satisfied, if the CPU 20 determines that the condition is satisfied (Yes in Act 11), the CPU 20 combines the benefit information and the number of registered items of benefit data to create benefit data and registers the benefit data in the benefit data registration area 22b formed in the RAM 22 (Act 12). Thereafter, the CPU 20 calculates a total price of the currently-registered commodity on the basis of the sales data registered in the sales data registration area 22a and the benefit data registered in the benefit data registration area 22b, updates a displayed total price with the calculated total price, and adds content of the sales data added anew to display content of the display unit 12 (Act 8). The CPU 20 shifts to the state for receiving scanning of a barcode again and waits for the next scanning (Acts 1 and 2).

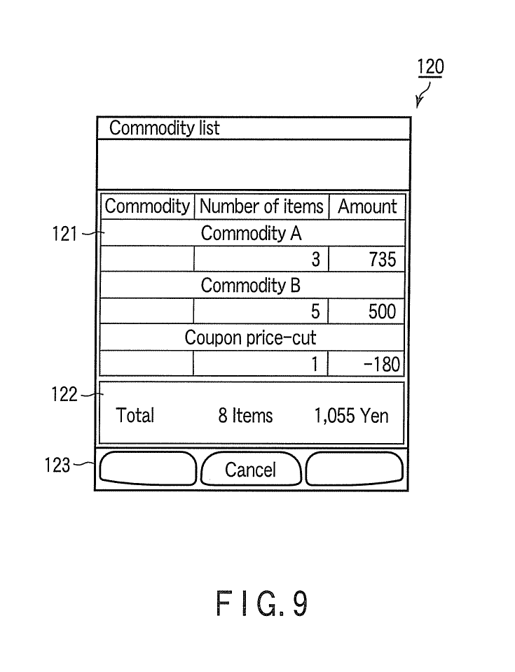

An example of a registration screen displayed on the display unit 12 when sales data is registered in the sales data registration area 22a and benefit data is registered in the benefit data registration area 22b is shown in FIG. 9. This registration screen 120 includes display areas 121 to 123.

In the display area 121, the sales data registered in the sales data registration area 22a and the benefit data registered in the benefit data registration area 22b are displayed.

In the display area 122, a total number of items of the sales data registered in the sales data registration area 22a and a total price of a relevant transaction are displayed.

In the display area 123, information for informing contents of processing performed when the operation buttons 113 to 115 are depressed is displayed.

In this example, sales data of a “commodity A” (three items, 735 yen) and a “commodity B” (five items, 500 yen) and benefit data of “coupon price-cut” (one item, −180 yen) are displayed in the display area 121. Guidance indicating that cancellation of a commodity selected by the operation of the operation button 114 is executed (“cancel”) is displayed in the display area 123. In this way, for example, the total price based on the currently-registered sales data and benefit data is displayed on the registration screen 120. Therefore, the customer can understand, even during shopping, how much the customer should finally pay.

On the other hand, if the benefit information received from the store server 1 is already registered in the benefit data registration area 22b (No in Act 9) and, as a result of determining whether the condition for use is satisfied, if it is determined that the condition is not satisfied (No in Act 11), the CPU 20 discards the benefit information. The CPU 20 displays, for example, a message for warning that the user cannot use the coupon on the display unit 12 via the display controller 25 (Act 13). The CPU 20 shifts to the state for receiving scanning of a barcode again and waits for the next scanning (Acts 1 and 2).

In this way, the customer scans barcodes attached to a purchased commodity and a coupon while selecting commodities in the store. When the customer reaches the register counter on which the POS terminal 2 to pay a price, the customer scans the settlement barcode 8. At this point, barcode data detected by the scanning and the barcode data of the settlement barcode 8 coincide with each other. Therefore, the CPU 20 determines that the scanned barcode is the settlement barcode 8 (Yes in Act 3) and transmits the registered contents of the sales data registration area 22a and the benefit data registration area 22b and the terminal ID of the handy terminal 4 to the POS terminal 2 (Act 14). Consequently, a series of sales data registration processing executed by the handy terminal 4 is completed.

Data transmitted from the handy terminal 4 is relayed by the access point 3 and transmitted to the POS terminal 2 via the LAN 5. The POS terminal 2 receives the data and executes settlement processing on the basis of received sales data. Specifically, the POS terminal 2 calculates a total price on the basis of the sales data in the received data, performs price-cut, discount, or the like according to content of benefit data, calculates a final total price of the transaction, and displays the final total price on the display unit 12. When the customer looks at this display and pays the price via the bill input unit and the coin input unit, the POS terminal 2 calculates change according to an input amount. The POS terminal 2 discharges the change via the bill discharge unit and the coin discharge unit and issues a receipt on which content of the transaction is printed by the receipt printer. Consequently, the settlement processing executed by the POS terminal 2 is completed.

The customer who finishes the settlement of the price returns the handy terminal 4 to the store and leaves the store carrying the purchased commodity.

As explained above, in a commodity sales system in this embodiment, the customer himself or herself can read a barcode of a coupon using the handy terminal 4 and register benefit information. Therefore, since the customer can input the benefit information related to the coupon at arbitrary timing during shopping, the customer is prevented from failing to use the coupon.

After the customer inputs the benefit information related to the coupon, since a total price with the benefit information taken into account is displayed on the display unit 12, the customer can understand an accurate price even during shopping.

Therefore, if the commodity sales system and the handy terminal 4 in this embodiment are used, serviceability for the customer is substantially improved. Further, according to a customer enclosure effect involved in the improvement of serviceability, improvement of sales of the store can be expected.

In the embodiment explained above, the customer scans barcodes attached to a commodity and a coupon with the scanner 27a and inputs a commodity code. However, other kinds of symbol codes such as a two-dimensional code may be used instead of the barcodes.

A method of inputting a benefit code is not limited to scanning of a barcode attached to a coupon. Other input systems may be used together with the method. For example, the customer may be able to input a benefit code described on a coupon in characters via the operation unit 11. Besides, it is also possible to provide a small camera such as a CCD camera in the handy terminal 4, photograph the characters or the like printed on the coupon with the camera, and detect benefit information from a photographed image using a character recognition function. Even when an input form of a benefit code and benefit information is changed in this way, the user can still input benefit information related to a coupon during shopping. Therefore, an effect same as that in the embodiment is realized.

It is also possible to store the PLU file 6 and the benefit information table 7 in storing means such as the RAM 22 or a hard disk drive included in the handy terminal 4 and specify commodity information from the PLU file 6 stored in the storing means without accessing the store server 1. In this case, in order to keep contents of the PLU file 6 and the benefit information table 7 up to date, it is also conceivable to make it possible to periodically update the PLU file 6 and the benefit information table 7 by, for example, automatically downloading the same from the store server 1 when a customer begins shopping.

In the embodiment, registered contents of the sales data registration area 22a and the benefit data registration area 22b are transmitted from the handy terminal 4 to the POS terminal 2 when the settlement barcode 8 is scanned. However, data may be transmitted from the handy terminal 4 to the POS terminal 2 by other methods. For example, a cradle that is communication-connected to the store server 1 and to which the handy terminal 4 is detachably attachable and a printer communication-connected to the cradle are set in predetermined positions in the store. When the handy terminal 4 is attached to the cradle, the handy terminal 4 transmits the identifier of the handy terminal 4 to the printer and causes the printer to print the identifier on a print medium. The handy terminal 4 transmits the registered contents of the sales data registration area 22a and the benefit data registration area 22b and the identifier of the handy terminal 4 to the store server 1 via the cradle. The store server 1 stores and manages the identifier received from the handy terminal 4 and the registered contents of the registration areas 22a and 22b in association with each other. When the customer having the medium, on which the identifier is printed by the printer, moves to the register and inputs the identifier to the POS terminal 2, the POS terminal 2 transmits the input identifier to the store server 1. The store server 1 returns data associated with the received identifier. The POS terminal 2 performs checkout processing on the basis of the data acquired in this way.

The numerical values, the names, and the like specifically described in the embodiment are merely examples. It goes without saying that it is possible to adopt a modification for applying the configuration disclosed in the embodiment to, for example, a commodity sales system including a plurality of the POS terminals 2 and a plurality of the access points 3.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A handy terminal comprising:
an information detecting unit configured to detect commodity information of a commodity purchased by a customer and benefit information indicating content of a benefit provided to the customer;
a storing unit configured to store the commodity information and the benefit information detected by the information detecting unit; and
an output unit configured to output the commodity information and the benefit information stored in the storing unit to a commodity sales data processing apparatus configured to subject the commodity indicated by the commodity information to sales processing.

2. The handy terminal according to claim 1, further comprising a reading unit configured to read a symbol code and input an identifier represented by the symbol code, wherein
the information detecting unit detects, on the basis of an identifier input when a symbol code attached to a commodity is read by the reading unit, commodity information of the commodity and detects, on the basis of an identifier input when a symbol code attached to a coupon is read by the reading unit, benefit information indicated by the coupon.

3. The handy terminal according to claim 2, further comprising a communication unit configured to communicate with a server apparatus, wherein
the information detecting unit transmits, with the communication unit, the identifier input when the symbol code attached to the commodity is read by the reading unit and the identifier input when the symbol code attached to the coupon is read by the reading unit to the server apparatus and receives, with the communication unit, commodity information and benefit information returned by the server apparatus according to the received identifiers to detect the commodity information and the benefit information.

4. The handy terminal according to claim 2, wherein the output unit outputs the commodity information and the benefit information stored in the storing unit to the commodity sales data processing apparatus when a predetermined symbol code is read by the reading unit and an identifier of the symbol code is input.

5. The handy terminal according to claim 1, further comprising:
a display unit;
a calculating unit configured to calculate a price of a relevant transaction on the basis of the commodity information and the benefit information stored in the storing unit; and
a display control unit configured to display the price calculated by the calculating unit on the display unit.

6. The handy terminal according to claim 5, wherein the display control unit displays, in addition to the price, the commodity information and the benefit information stored in the storing unit on the display unit.

7. The handy terminal according to claim 1, further comprising a storage control unit configured to store, when benefit information same as the benefit information detected by the information detecting unit is not stored in the storing unit, the detected benefit information in the storing unit and discard, when benefit information same as the benefit information detected by the information detecting unit is stored in the storing unit, the detected benefit information.

8. The handy terminal according to claim 1, further comprising:
a condition detecting unit configured to detect a condition for application of content of a benefit indicated by the benefit information detected by the information detecting unit; and
a storage control unit configured to store, when the application condition detected by the condition detecting unit is satisfied, the benefit information detected by the information detecting unit in the storing unit and discard, when the application condition is not satisfied, the benefit information detected by the information detecting unit.

9. A commodity sales system in which a server apparatus, a handy terminal used by a customer himself or herself to register commodity information, and a commodity sales data processing apparatus configured to subject a commodity to sales processing are communication-connected by wire or radio, wherein
the server apparatus includes:
a commodity-information storing unit having stored therein commodity information in association with identifiers of commodities;
a benefit-information storing unit having stored therein benefit information in association with identifiers of benefits provided to customers;
an information specifying unit configured to specify, when an identifier of a commodity is received from the handy terminal, commodity information associated with the identifier from the commodity-information storing unit and specify, when an identifier of a benefit is received from the handy terminal, benefit information associated with the identifier from the benefit information storing unit; and
a return control unit configured to return the commodity information and the benefit information specified by the information specifying unit to the handy terminal,
the handy terminal includes:
a reading unit configured to read symbol codes attached to a commodity and a coupon and input identifiers represented by the symbol codes;
a transmission and reception control unit configured to transmit, to the server apparatus, an identifier input when the symbol code attached to the commodity is read by the reading unit and an identifier input when the symbol code attached to the coupon is read by the reading unit and receive commodity information and benefit information returned from the server apparatus;
a storing unit configured to store the commodity information and the benefit information received by the transmission and reception control unit; and
an output unit configured to output the commodity information and the benefit information stored in the storing unit to the commodity sales data processing apparatus, and
the commodity sales data processing apparatus subjects, on the basis of the commodity information and the benefit information output from the handy terminal, a commodity indicated by the commodity information to the sales processing.

10. A method of controlling a handy terminal including a reading unit configured to read a symbol code and input an identifier represented by the symbol code, the handy terminal being used in a commodity sales system of a self scanning type in which a customer himself or herself performs a registration job for commodity information, the method comprising:
detecting, on the basis of an identifier input when a symbol code attached to a commodity is read by the reading unit, commodity information of the commodity;
detecting, on the basis of an identifier input when a symbol code attached to a coupon is read by the reading unit, benefit information indicated by the coupon;
storing the detected commodity information and benefit information in a predetermined storing unit; and
outputting the commodity information and the benefit information stored in the storing unit to a commodity sales data processing apparatus configured to subject the commodity indicated by the commodity information to sales processing.
